(19) United States
(12) Patent Application Publication
(10) Pub. No.: US 2015/0010743 A1
(43) Pub. Date: Jan. 8, 2015

(54) FILMS INCLUDING A COPOLYMER, ARTICLES AND METHODS

(71) Applicant: 3M INNOVATIVE PROPERTIES COMPANY, St. Paul, MN (US)

(72) Inventors: Rajesh K. Katare, Cottage Grove, MN (US); Timothy J. Hebrink, Scandia, MN (US); Mark B. O'Neill, Stillwater, MN (US)

(73) Assignee: 3INNOVATIVE PROPERTIES COMPANY, St. Paul, MN (US)

(21) Appl. No.: 14/374,993

(22) PCT Filed: Jan. 30, 2013
(86) PCT No.: PCT/US2013/023783

§ 371 Date: Jul. 28, 2014

Related U.S. Application Data
(60) Provisional application No. 61/593,104, filed on Jan. 31, 2012.

(51) Int. Cl. C08L 53/00; B29C 47/00; B29C 47/88; C08J 5/18

(52) U.S. Cl. CPC C08L 53/00; C08J 5/18; B29C 47/0021; B29C 47/0004; B29C 47/884; C08J 2353/00; C08J 2427/16; C08J 2433/12; B29K 2105/0088
USPC 428/215; 428/421; 525/94; 524/505; 264/176.1

(57) ABSTRACT

A film including poly(vinylidene fluoride) and a block copolymer with at least two endblock polymeric units that are each derived from a first monoethylenically unsaturated monomer selected from a methacrylate, acrylate, styrene, or combination thereof; and at least one midblock polymeric unit is derived from a second monoethylenically unsaturated monomer selected from a methacrylate, acrylate, vinyl ester, or combination thereof, each endblock having a glass transition temperature of at least 50° C., and each midblock having a glass transition temperature no greater than 20° C. The film may further include poly(methyl methacrylate). The film may be a multilayer film with a first outer layer and a second outer layer opposite the first outer layer. The multilayer film may include a multiplicity of interior layers between the first and second outer layers, or the first outer layer may be adjacent to the second outer layer. Articles and methods are also disclosed.

### CROSS REFERENCE TO RELATED APPLICATIONS

This application claims the benefit of U.S. Provisional Application No. 61/593,104, filed Jan. 31, 2012, the disclosure of which is incorporated by reference herein in its entirety.

### TECHNICAL FIELD

The present disclosure relates to copolymeric film substrates and related articles and methods of manufacture. More particularly, the disclosed copolymeric film substrates may, in some embodiments, provide optically clear substrates useful in display, lighting, and solar energy applications.

### BACKGROUND

Polymeric films are widely used as substrates for various purposes, for example, as light transmissive substrates, due to their light weight, flexibility, and resistance to breakage as compared to glass. Examples of a wide variety of light transmissive films, including multilayer films, are described in the commonly assigned U.S. Pat. No. 5,882,774, entitled “Optical Film”. Exemplary applications for such optical films include, for example, use in compact electronic display applications, e.g. liquid crystal displays (LCDs) and organic light emitting diode (OLED) displays found in electronic devices such as mobile telephones, personal data assistants, computers, televisions and the like; and use in solar energy applications, e.g. solar photovoltaic devices, solar thermal reflector devices, solar light control films, and the like.

### SUMMARY

Often time articles used in compact electronic display and/or solar energy applications are encapsulated in glass or a weather durable (co)polymer film. Glass offers much better protection from ultraviolet radiation, surface hardness and permeability, but (co)polymers offer lower cost, lower weight and easy manufacturing processes. However, when most (co)polymeric films are exposed to solar radiation (e.g. ultraviolet, visible and infrared radiation), weathering (e.g. exposure to heat, precipitation, humidity, rain, condensation, blowing dirt and/or sand, freezing and thawing cycles), aggressive cleaning, and/or careless handling, the films may yellow, crack, corrode, lose adhesion, tunnel, and/or become scratched, thereby causing a loss in optical clarity (e.g., transmissivity) commonly referred to as haze.

This disclosure describes copolymer films, articles and methods for making optically clear substrates that show, in some exemplary embodiments, low haze, excellent weatherability, corrosion resistance, toughness and adhesion to metals, metal oxides and organic materials. Such optically clear film substrates can be particularly useful in compact electronic display and solar energy applications.

Thus, in one aspect, the disclosure describes a film including poly(vinylidene fluoride) and a first block copolymer with at least two endblock polymeric units that are each derived from a first monoethylenically unsaturated monomer including a methacrylate, acrylate, styrene, or combination thereof, wherein each endblock has a glass transition temperature of at least 50° C.; and at least one midblock polymeric unit that is derived from a second monoethylenically unsaturated monomer including a methacrylate, acrylate, vinyl ester, or combination thereof, wherein each midblock has a glass transition temperature no greater than 20° C. In some exemplary embodiments, the film further includes poly(methyl methacrylate). In certain exemplary embodiments of any of the foregoing, the poly(vinylidene fluoride), the first block copolymer, and the poly(methyl methacrylate), if present, are blended together within the film, preferably to form a homogenous mixture.

In some exemplary embodiments of the foregoing films, the film is a multilayer film including a first outer layer and a second outer layer opposite the first outer layer. In certain such exemplary embodiments, each of the first outer layer and the second outer layer has a thickness of from 0.1 micrometer to 250 micrometers. In further such exemplary embodiments, the film further includes at least one interior layer between the first and second outer layers. In certain such exemplary embodiments, the at least one interior layer is one interior layer having a thickness of from 0.1 micrometer to 250 micrometers. In other such exemplary embodiments, the at least one interior layer includes a multiplicity of interior layers. In certain such exemplary embodiments, the multiplicity of interior layers have a combined thickness of from 0.2 micrometer to 1,000 micrometers.

In other exemplary embodiment, the multilayer film is a dual (i.e. two) layer film wherein the first outer layer is adjacent to the second outer layer. In some such exemplary embodiments, the first and second outer layers each have a thickness of from 0.1 micrometer to 500 micrometers.

In additional exemplary embodiments of any of the foregoing films, the film further includes a (meth)acrylate (co)polymer derived by radiation curing one or more radiation-curable (meth)acrylic monomers. In certain such exemplary embodiments, the (meth)acrylate (co)polymer is included in the film in an amount from 10 wt. % to 90 wt. % based on the total weight of any poly(methyl methacrylate), the poly(vinylidene fluoride), and the first block copolymer included in the film. In some exemplary multilayer film embodiments, the first outer layer includes a blend of the poly(methyl methacrylate), the poly(vinylidene fluoride), and the (meth)acrylate (co)polymer, and the second outer layer includes the first block copolymer. In other such exemplary multilayer film embodiments, the first outer layer includes a blend of the poly(methyl methacrylate) and the (meth)acrylate (co)polymer, and the second outer layer includes a blend of the poly(vinylidene fluoride) and the first block copolymer. In additional exemplary multilayer film embodiments, the first outer layer includes a blend of the (meth)acrylate (co)polymer and a portion of the poly(methyl methacrylate), and the second outer layer comprises a blend of the poly(vinylidene fluoride), the first block copolymer, and a remaining portion of the (meth)acrylate (co)polymer not included in the first outer layer.

In further exemplary embodiments of any of the foregoing films, each endblock includes poly(methyl methacrylate) and each midblock includes poly(butyl acrylate). In certain such exemplary embodiments the first block copolymer includes from 30 wt. % to 80 wt. % endblocks, and from 20 wt. % to 70 wt. % midblocks, based on the total weight of the first block copolymer. In some such exemplary embodiments, the first block copolymer includes from 50 wt. % to 70 wt. % endblocks, and from 30 wt. % to 50 wt. % midblocks, based on the total weight of the first block copolymer.

In additional exemplary embodiments of any of the foregoing films, poly(methyl methacrylate) is included in the film in an amount from 1 wt. % to 55 wt. % based on the total weight of the poly(methyl methacrylate), the poly(vinylidene fluoride), and the first block copolymer in the film. In other exemplary embodiments of any of the foregoing, the poly(vinylidene fluoride) is included in the film in an amount from 5 wt. % to 75 wt. % based on the total weight of poly(methyl methacrylate) if present, the poly(vinylidene fluoride), and the first block copolymer in the film. In additional exemplary embodiments of any of the foregoing, the first block copolymer is included in the film in an amount from 5 wt. % to 75 wt. % based on the total weight of poly(methyl methacrylate) if present, the poly(vinylidene fluoride), and the first block copolymer in the film.

In additional exemplary embodiments of any of the foregoing, the single or multilayer film further includes at least one additional block copolymer having endblocks including poly(methyl methacrylate) and a midblock including poly(butyl acrylate), wherein the at least one additional block copolymer is compositionally distinct from the first block copolymer.

In further exemplary embodiments of any of the foregoing films, the film further includes at least one ultraviolet (UV) light absorber in an amount from 0.1 wt. % to 10 wt. %. In certain such exemplary embodiments, the film further includes at least one hindered amine light stabilizer (HALS) in an amount from 0.1 wt. % to 1 wt. %. Optionally, the UV light absorber is present in an amount from 0.5 wt. % to 5 wt. %.

In additional exemplary embodiments of any of the foregoing films, the film further includes a multiplicity of inorganic nanoparticulates having a median particle diameter of less than one micrometer. In some such exemplary embodiments, the inorganic nanoparticulates are metal oxide particulates selected from titanium dioxide, aluminum oxide, silicon dioxide, indium oxide, tin oxide, zinc oxide, zirconium oxide, and combinations thereof.

Preferably, the foregoing films are visible light-transmissive or optically clear, exhibiting, in some exemplary embodiments, an average radiation transmission over the visible light portion of the radiation spectrum from 380 nm to 780 nm (Tᵥᵢₛ) of at least about 90%, measured along the normal axis. Additionally and more preferably, in some exemplary embodiments the foregoing films exhibit an average radiation transmission of at least 90% over the solar radiation wavelength range from 380 nm to 3,000 nm (Tₛₒₗₐᵣ).

In another aspect the disclosure describes an article including any of the foregoing films. In certain such exemplary embodiments, the article is selected from an organic light emitting display, a lighting element, a solar reflector, a photovoltaic cell, a mirror, a window, a graphic arts display, a sign, or a combination thereof.

In a further aspect, the disclosure discloses methods of making any of the foregoing films, the method including providing a molten poly(vinylidene fluoride), providing a molten block copolymer having at least two endblock polymeric units that are each derived from a first monoethylenically unsaturated monomer comprising a methacrylate, acrylate, styrene, or combination thereof, wherein each endblock has a glass transition temperature of at least 50° C.; and at least one midblock polymeric unit that is derived from a second monoethylenically unsaturated monomer comprising a methacrylate, acrylate, vinyl ester, or combination thereof, wherein each midblock has a glass transition temperature no greater than 20° C., passing the molten poly(vinylidene fluoride) and the molten block copolymer through a film extrusion die; and after exiting the film extrusion die, cooling the molten poly(vinylidene fluoride) and the molten block copolymer to a temperature of about room temperature (i.e., 23.0+/−3.4° C.) to form the film.

In some exemplary embodiments, the method further includes providing a molten poly(methyl methacrylate), passing the molten poly(methyl methacrylate) through a film extrusion die, optionally wherein passing the molten poly(methyl methacrylate) through the film extrusion die is simultaneous with passing the molten poly(vinylidene fluoride) and the molten block copolymer through the film extrusion die, and after exiting the film extrusion die, cooling the molten poly(methyl methacrylate) to a temperature of about room temperature.

In some exemplary embodiments of any of the foregoing, the film is a multilayer film including a first outer layer and a second outer layer opposite said first outer layer. In certain such exemplary multilayer film embodiments, the first outer layer includes a blend of the poly(methyl methacrylate), the poly(vinylidene fluoride), and the (meth)acrylate (co)polymer, and the second outer layer includes the first block copolymer. In other exemplary multilayer film embodiments, the first outer layer includes a blend of the poly(methyl methacrylate) and the (meth)acrylate (co)polymer, and the second outer layer includes a blend of the poly(vinylidene fluoride) and the first block copolymer. In additional exemplary multilayer film embodiments, the first outer layer includes a blend of the (meth)acrylate (co)polymer and a portion of the poly(methyl methacrylate), and the second outer layer includes a blend of the poly(vinylidene fluoride), the first block copolymer, and the remaining portion of the (meth)acrylate (co)polymer not included in the first outer layer. In some exemplary multilayer film embodiments, the film includes at least one interior layer between the first and second outer layers.

The exemplary films and articles of the present disclosure, in some exemplary embodiments, advantageously exhibit high optical transmissivity and low haze and yellowing, good weatherability, good abrasion, scratch and crack resistance during to handling and cleaning, and good adhesion to other layers, for example, other (co)polymer layers, metal oxide layers, and metal layers applied to one or both major surfaces of the films when used as substrates, for example, in compact electronic display and/or solar energy applications.

Various aspects and advantages of exemplary embodiments of the disclosure have been summarized. The above Summary is not intended to describe each illustrated embodiment or every implementation of the present invention. The Drawings and the Detailed Description that follow more particularly exemplify certain preferred embodiments using the principles disclosed herein.

### BRIEF DESCRIPTION OF THE DRAWINGS

Exemplary embodiments of the present disclosure are further described with reference to the appended drawings, wherein:

FIG. 1A is a side view showing an exemplary single-layer copolymeric film of an embodiment of the present disclosure.

FIG. 1B is a side view showing an exemplary multi-layer (two layer) copolymeric film of additional exemplary embodiments of the present disclosure.

FIG. 1C is a side view showing an exemplary multi-layer (three layer) copolymeric film of further exemplary embodiments of the present disclosure.

While the above-identified drawings, which may not be drawn to scale, set forth various embodiments of the present disclosure, other embodiments are also contemplated, as noted in the Detailed Description. In all cases, this disclosure describes the presently disclosed invention by way of representation of exemplary embodiments and not by express limitations. It should be understood that numerous other modifications and embodiments can be devised by those skilled in the art, which fall within the scope and spirit of this invention.

### DETAILED DESCRIPTION

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following Glossary of defined terms, these definitions shall be applied for the entire application, unless a different definition is provided in the claims or elsewhere in the specification.

### GLOSSARY

The term “polymer” or “(co)polymer” includes homopolymers and copolymers, as well as homopolymers or copolymers that may be formed in a miscible blend, e.g., by coextrusion or by reaction, including, e.g., transesterification. The term “copolymer” includes random, block and star (e.g. dendritic) copolymers.

The terms “(meth)acrylate,” “(meth)acrylic” or “(meth)acrylic-functional” include monomers that having one or more ethylenically unsaturated acrylic- and/or methacrylic-functional groups: e.g., -AC(O)C(R)═CH₂, preferably wherein A is O, S or NR; and R is a 1-24 carbon lower alkyl group, H, F or Si; and materials (e.g. (co)polymers) derived by polymerization of such monomers.

The term “molecularly same (co)polymer(s)” means (co)polymers that have essentially the same repeating molecular unit, but which may differ in molecular weight, method of manufacture, commercial form, and the like.

The term “crosslinked” (co)polymer refers to a (co)polymer whose molecular chains are joined together by covalent chemical bonds, usually via crosslinking molecules or groups, to form a network polymer. A crosslinked (co)polymer is generally characterized by insolubility, but may be swellable in the presence of an appropriate solvent.

By using the term “T_{g}”, we refer to the glass transition temperature of a cured (co)polymer when evaluated in bulk rather than in a thin film form. In instances where a polymer can only be examined in thin film form, the bulk form T_{g} can usually be estimated with reasonable accuracy. Bulk form T_{g} values usually are determined by evaluating the rate of heat flow vs. temperature using differential scanning calorimetry (DSC) to determine the onset of segmental mobility for the (co)polymer and the inflection point (usually a second-order transition) at which the polymer can be said to change from a glassy to a rubbery state. Bulk form T_{g} values can also be estimated using a dynamic mechanical thermal analysis (DMTA) technique, which measures the change in the modulus of the (co)polymer as a function of temperature and frequency of vibration.

By using the terms “visible light-transmissive” or “optically clear” with reference to a film or layer, we mean that the film or layer exhibits an average radiation transmission over the visible light portion of the radiation spectrum from 380 nm to 780 nm (Tᵥᵢₛ) of at least about 90%, measured along the normal axis, and more preferably, additionally exhibits an average radiation transmission of at least 90% over the solar radiation wavelength range from 380 nm to 3,000 nm (Tₛₒₗₐᵣ).

The term “metal” includes a pure or elemental metal or a metal alloy.

The term “ambient temperature(s)” or “room temperature(s)” refers to a temperature in the range of 20° C. to 26° C.

The term “layer” means a single stratum formed between two major surfaces. A layer may exist internally within a single web, e.g., a single stratum formed with multiple strata in a single web having first and second major surfaces defining the thickness of the web. A layer may also exist in a composite article comprising multiple webs, e.g., a single stratum in a first web having first and second major surfaces defining the thickness of the web, when that web is overlaid or underlaid by a second web having first and second major surfaces defining the thickness of the second web, in which case each of the first and second webs forms at least one layer. In addition, layers may simultaneously exist within a single web and between that web and one or more other webs, each web forming a layer.

The term “adjoining” with reference to a particular first layer means joined with or attached to another, second layer, in a position wherein the first and second layers are either next to (i.e., adjacent to) and directly contacting each other, or contiguous with each other but not in direct contact (i.e., there are one or more additional layers intervening between the first and second layers).

By using terms of orientation such as “atop”, “on”, “covering”, “uppermost”, “underlying” and the like for the location of various elements in the disclosed coated articles, we refer to the relative position of an element with respect to a horizontally-disposed, upwardly-facing substrate. It is not intended that the substrate or articles should have any particular orientation in space during or after manufacture.

By using the term “overcoated” to describe the position of a layer with respect to a substrate or other element of a film of this disclosure, we refer to the layer as being atop the substrate or other element, but not necessarily contiguous to either the substrate or the other element.

By using the term “separated by” to describe the position of a polymer layer with respect to two inorganic barrier layers, we refer to the polymer layer as being between the inorganic barrier layers but not necessarily contiguous to either inorganic barrier layer.

Various exemplary embodiments of the disclosure will now be described with particular reference to the Drawings. Exemplary embodiments of the invention may take on various modifications and alterations without departing from the spirit and scope of the disclosure. Accordingly, it is to be understood that the embodiments of the invention are not to be limited to the following described exemplary embodiments, but is to be controlled by the limitations set forth in the claims and any equivalents thereof.

Provided herein are copolymer films, related articles and methods of manufacturing the same.

### Copolymer Films

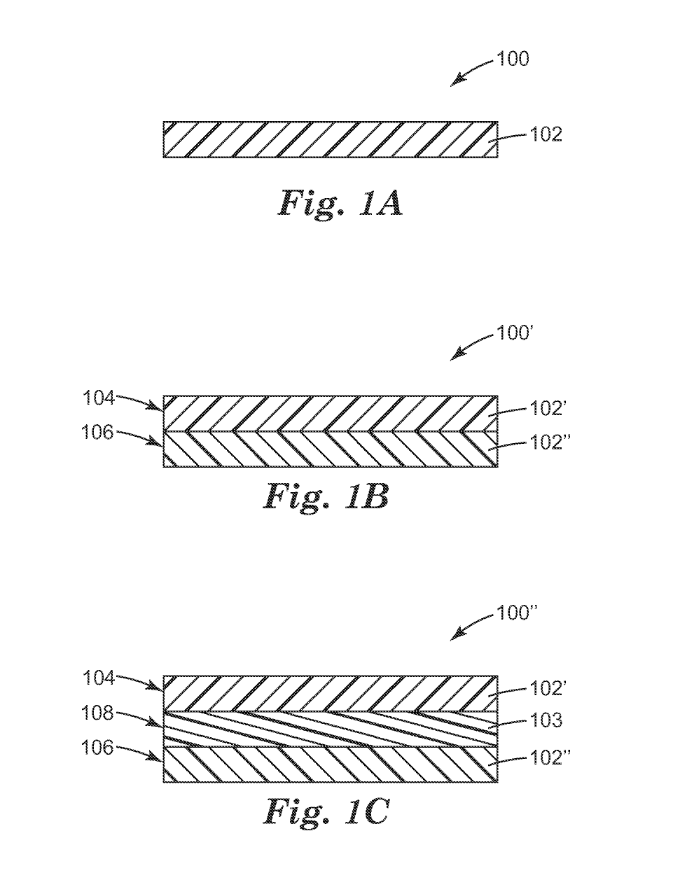

Thus, in one aspect, the disclosure provides a film comprising a copolymer. An exemplary single layer film is shown in FIG. 1A and broadly denoted by the numeral 100. As shown, the film comprises a single (base) layer 102 having opposed major surfaces.

In some exemplary embodiments, the film is a multilayer film as illustrated by FIGS. 1A-1B.

FIG. 1B illustrates another exemplary film, a two (dual) layer film 100′ comprising a first outer layer 104 having a composition 102′ and a second outer layer 106 having a composition 102″ opposite the first outer layer 104, wherein the first outer layer 104 is adjacent to the second outer layer 106. In some such exemplary dual layer films 100′, the first 104 and second 106 outer layers each have a thickness of from 0.1 micrometer to 500 micrometers.

In other exemplary multilayer film embodiments illustrated in FIG. 1C, the multilayer film 100″ comprises a first outer layer 104 having a composition 102′ and a second outer layer 106 having a composition 102″ opposite the first outer layer 104, and further comprises at least one interior layer 108 having a composition 103, positioned between the first 104 and second 106 outer layers. In certain such exemplary multilayer films 100″ comprising at least one interior layer 108, the at least one interior layer 108 is one interior layer 108 having a thickness of from 0.1 micrometer to 250 micrometers. In other such exemplary multilayer film embodiments comprising at least one interior layer 108, the at least one interior layer 108 includes a plurality of interior layers 103 (additional layers 103 are not shown in the Drawings). In certain such exemplary multilayer layer films 100″ comprising a plurality of interior layers 103, each of the first outer layer 104 and the second outer layer 106 has a thickness of from 0.1 micrometer to 250 micrometers. In certain such exemplary embodiments, the plurality of interior layers 103 have a combined thickness of from 0.2 micrometer to 1,000 micrometers.

### Copolymer Film Components

The single layer 100, dual layer 100′ or multilayer 100″ films comprise poly(vinylidene fluoride) and a first block copolymer with at least two endblock polymeric units that are each derived from a first monoethylenically unsaturated monomer including a methacrylate, acrylate, styrene, or combination thereof, wherein each endblock has a glass transition temperature of at least 50° C.; and at least one midblock polymeric unit that is derived from a second monoethylenically unsaturated monomer including a methacrylate, acrylate, vinyl ester, or combination thereof, wherein each midblock has a glass transition temperature no greater than 20° C. In some exemplary embodiments, the film optionally further includes poly(methyl methacrylate). Preferably, the copolymer film is non-tacky.

In certain exemplary embodiments of any of the foregoing films, the poly(vinylidene fluoride), the first block copolymer, and the poly(methyl methacrylate), if present, are blended together within the single layer film 100, or within a layer forming a dual layer 100′ or multilayer 100″ film, preferably to form a homogenous mixture.

In other exemplary dual 100′ or multilayer 100″ film embodiments, the first outer layer includes a blend of the poly(methyl methacrylate), the poly(vinylidene fluoride), and the (meth)acrylate (co)polymer, and the second outer layer includes the first block copolymer. Such exemplary embodiments may be preferred for good weatherability and adhesion of other layers, for example, other polymer, metal oxide, or metal layers.

In further exemplary multilayer film embodiments, the first outer layer includes a blend of the poly(methyl methacrylate) and the (meth)acrylate (co)polymer, and the second outer layer includes a blend of the poly(vinylidene fluoride) and the first block copolymer. Such exemplary embodiments may be preferred for surface hardness.

In additional exemplary multilayer film embodiments, the first outer layer includes a blend of the (meth)acrylate (co)polymer and a portion of the poly(methyl methacrylate), and the second outer layer comprises a blend of the poly(vinylidene fluoride), the first block copolymer, and a remaining portion of the (meth)acrylate (co)polymer not included in the first outer layer. Such exemplary embodiments may be preferred for low cost and film toughness (e.g. durability).

In further exemplary embodiments of any of the foregoing films, each endblock includes poly(methyl methacrylate) and each midblock includes poly(butyl acrylate). In certain such exemplary embodiments the first block copolymer includes from 30 wt. % to 80 wt. % endblocks, and from 20 wt. % to 70 wt. % midblocks, based on the total weight of the first block copolymer. In some such exemplary embodiments, the first block copolymer includes from 50 wt. % to 70 wt. % endblocks, and from 30 wt. % to 50 wt. % midblocks, based on the total weight of the first block copolymer.

### Polyvinylidene Fluoride

The single layer 100, dual layer 100′ or multilayer 100″ films comprise poly(vinylidene fluoride) (PVDF). Preferably, the PVDF is included in the film in an amount from 5 wt. % to 75 wt. % based on the total weight of poly(methyl methacrylate) if present, the poly(vinylidene fluoride), and the first block copolymer in the film.

### Block Copolymers

In exemplary embodiments, the provided copolymer films are single 100, dual 100′ or multilayer 100″ films that include one or more block copolymers. As used herein, the term “block copolymer” refers to a polymeric material that includes a plurality of distinct polymeric segments (or “blocks”) that are covalently bonded to each other. A block copolymer includes (at least) two different polymeric blocks, commonly referred to as the A block and the B block. The A block and the B block generally have chemically dissimilar compositions with different glass transition temperatures.

Further, each of the A and B blocks includes a plurality of respective polymeric units. The A block polymeric units, as well as the B block polymeric units, are generally derived from monoethylenically unsaturated monomers. Each polymeric block and the resulting block copolymer have a saturated polymeric backbone without the need for subsequent hydrogenation.

An “ABA” triblock copolymer has a pair of A endblocks covalently coupled to a B midblock. As used herein, the term “endblock” refers to the terminal segments of the block copolymer and the term “midblock” refers to the central segment of the block copolymer. The terms “A block” and “A endblock” are used interchangeably herein. Likewise, the terms “B block” and “B midblock” are used interchangeably herein.

The block copolymer with at least two A block and a least one B block can also be a star block copolymer having at least three segments of formula (A-B)—. Star block copolymers often have a central region from which various branches extend. In these cases, the B blocks are typically in the central regions and the A blocks are in the terminal regions of the star block copolymers.

In preferred embodiments, the A blocks are more rigid than the B block. That is, the A blocks have a higher glass transition temperature and have a higher hardness than that of the B block. As used herein, the term “glass transition temperature,” or “T_{g},” refers to the temperature at which a polymeric material undergoes a transition from a glassy state to a rubbery state. The glassy state is typically associated with a material that is, for example, brittle, stiff, rigid, or a combination thereof. In contrast, the rubbery state is typically associated with a material that is flexible and/or elastomeric. The B block is commonly referred to as a soft block while the A blocks are referred to as hard blocks.

The glass transition temperature can be determined using a method such as Differential Scanning calorimetry (DSC) or Dynamic Mechanical Analysis (DMA). Preferably, the A blocks have a glass transition temperature of at least 50° C. and the B block has a glass transition temperature no greater than 20° C. In exemplary block copolymers, the A blocks have a T_{g} of at least 60° C., at least 80° C., at least 100° C., or at least 120° C. while the B block has a glass transition temperature no greater than 10° C., no greater than 0° C., no greater than −5° C., or no greater than −10° C.

In some embodiments, the A block component is a thermoplastic material while the B block component is an elastomeric material. As used herein, the term “thermoplastic” refers to a polymeric material that flows when heated and that returns to its original state when cooled back to room temperature. As used herein, the term “elastomeric” refers to a polymeric material that can be stretched to at least twice its original length and then retracted to approximately its original length upon release.

The solubility parameter of the A blocks is preferably substantially different from the solubility parameter of the B block. Stated differently, the A blocks are typically not compatible or miscible with the B block, and this generally results in localized phase separation, or “microphase separation”, of the A and B blocks. Microphase separation can advantageously impart elastomeric properties and dimensional stability to a block copolymer material.

In some embodiments, the block copolymer has a multiphase morphology, at least at temperatures in the range of about 20° C. to 150° C. The block copolymer can have distinct regions of reinforcing A block domains (e.g., nanodomains) in a matrix of the softer, elastomeric B block. For example, the block copolymer can have a discrete, discontinuous A block phase in a substantially continuous B block phase. In some such examples, the concentration of A block polymeric units is no greater than about 35 weight percent of the block copolymer. The A blocks usually provide the structural and cohesive strength for the block copolymer.

The monoethylenically unsaturated monomers that are suitable for the A block polymeric units preferably have a T_{g} of at least 50° C. when reacted to form a homopolymer. In many examples, suitable monomers for the A block polymeric units have a T_{g} of at least 60° C., at least 80° C., at least 100° C., or at least 120° C. when reacted to form a homopolymer. The T_{g} of these homopolymers can be up to 200° C. or up to 150° C. The T_{g} of these homopolymers can be, for example, in the range of 50° C. to 200° C., 50° C. to 150° C., 60° C. to 150° C., 80° C. to 150° C., or 100° C. to 150° C. In addition to these monomers having a T_{g} of at least 50° C. when reacted to form a homopolymer, other monomers can be optionally included in the A block while the T_{g} of the A block remains at least 50° C.

The A block polymeric units may be derived from methacrylate monomers, styrenic monomers, or a mixture thereof. That is, the A block polymeric units may be the reaction product of a monoethylenically unsaturated monomer that is selected from a methacrylate monomer, styrenic monomer, or mixture thereof.

As used herein to describe the monomers used to form the A block polymeric units, the term “mixture thereof” means that more than one type of monomer (e.g., a methacrylate and styrene) or more than one of the same type of monomer (e.g., two different methacrylates) can be mixed. The at least two A blocks in the block copolymer can be the same or different. In many block copolymers all of the A block polymeric units are derived from the same monomer or monomer mixture.

In some embodiments, methacrylate monomers are reacted to form the A blocks. That is, the A blocks are derived from methacrylate monomers. Various combinations of methacrylate monomers may be used to provide an A block having a T_{g} of at least 50° C. The methacrylate monomers can be, for example, alkyl methacrylates, aryl methacrylates, or aralkyl methacrylate of Formula (I):

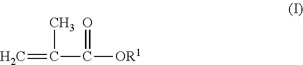

In Formula (I), R(1) is an alkyl, aryl, or aralkyl (i.e., an alkyl substituted with an aryl group).

Suitable alkyl groups often have 1 to 6 carbon atoms, 1 to 4 carbon atoms, or 1 to 3 carbon atoms. When the alkyl group has more than 2 carbon atoms, the alkyl group can be branched or cyclic. Suitable aryl groups often have 6 to 12 carbon atoms. Suitable aralkyl groups often have 7 to 18 carbon atoms.

Exemplary alkyl methacrylates of Formula (I) include, but are not limited to, methyl methacrylate, ethyl methacrylate, isopropyl methacrylate, isobutyl methacrylate, tert-butyl methacrylate, and cyclohexyl methacrylate. In addition to the monomers of Formula (I), isobornyl methacrylate can be used. Exemplary aryl (meth)acrylates of Formula (I) include, but are not limited to, phenyl methacrylate. Exemplary aralkyl methacrylates of Formula (I) include, but are not limited to, benzyl methacrylate and 2-phenoxyethyl methacrylate.

In other embodiments, the A block polymeric units are derived from styrenic monomers. Exemplary styrenic monomers that can be reacted to form the A blocks include, but are not limited to, styrene, alpha-methylstyrene, and various alkyl substituted styrenes such as 2-methylstyrene, 4-methylstyrene, ethylstyrene, tert-butylstyrene, isopropylstyrene, and dimethylstyrene.

In addition to the monomers described above for the A blocks, these polymeric units can be prepared using up to 5 weight percent of the polar monomer such as methacrylamide, N-alkyl methacrylamide, N,N-dialkyl methacrylamide, or hydroxyalkyl methacrylate. These polar monomers can be used, for example, to adjust the cohesive strength of the A block and the glass transition temperature. Preferably, the T_{g} of each A block remains at least 50° C. even with the addition of the polar monomer. Polar groups resulting from the polar monomers in the A block can function as reactive sites for chemical or ionic crosslinking, if desired.

The A block polymeric units can be prepared using up to 4 weight percent, up to 3 weight percent, or up to 2 weight percent of the polar monomer. In many examples, however, the A block polymeric units are substantially free or free of a polar monomer.

As used herein, the term “substantially free” in reference to the polar monomer means that any polar monomer that is present is an impurity in one of the selected monomers used to form the A block polymeric units.

The amount of polar monomer is less than 1 weight percent, less than 0.5 weight percent, less than 0.2 weight percent, or less than 0.1 weight percent of the monomers in the reaction mixture used to form the A block polymeric units.

The A block polymeric units are often homopolymers. In exemplary A blocks, the polymeric units are derived from an alkyl methacrylate monomers with the alkyl group having 1 to 6, 1 to 4, 1 to 3, 1 to 2, or 1 carbon atom. In some more specific examples, the A block polymeric units are derived from methyl methacrylate (i.e., the A blocks are poly(methyl methacrylate)).

The monoethylenically unsaturated monomers that are suitable for use in the B block polymeric unit usually have a T_{g} no greater than 20° C. when reacted to form a homopolymer. In many examples, suitable monomers for the B block polymeric unit have a T_{g} no greater than 10° C., no greater than 0° C., no greater than −5° C., or no greater than −10° C. when reacted to form a homopolymer.

The T_{g} of these homopolymers is often at least −80° C., at least −70° C., at least −60° C., or at least −50° C. The T_{g} of these homopolymers can be, for example, in the range of −80° C. to 20° C., −70° C. to 10° C., −60° C. to 0° C., or −60° C. to −10° C. In addition to these monomers having a T_{g} no greater than 20° C. when reacted to form a homopolymer, other monomers can be included in the B block while keeping the T_{g} of the B block no greater than 20° C.

The B midblock polymeric unit is typically derived from (meth)acrylate monomers, vinyl ester monomers, or a combination thereof. That is, the B midblock polymeric unit is the reaction product of a second monomer selected from (meth)acrylate monomers, vinyl ester monomers, or mixtures thereof. As used herein, the term “(meth)acrylate” refers to both methacrylate and acrylate. More than one type of monomer (e.g., a (meth)acrylate and a vinyl ester) or more than one of the same type of monomer (e.g., two different (meth)acrylates) can be combined to form the B midblock polymeric unit.

In many embodiments, acrylate monomers are reacted to form the B block. The acrylate monomers can be, for example, an alkyl acrylate or a heteroalkyl acrylate. The B blocks are often derived from acrylate monomers of Formula (II):

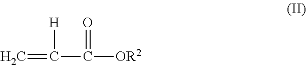

In Formula (II), R² is an alkyl with 1 to 22 carbons or a heteroalkyl with 2 to 20 carbons and 1 to 6 heteroatoms selected from oxygen or sulfur.

The alkyl or heteroalkyl group can be linear, branched, cyclic, or a combination thereof. Exemplary alkyl acrylates of Formula (II) that can be used to form the B block polymeric unit include, but are not limited to, ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, isooctyl acrylate, isononyl acrylate, decyl acrylate, isodecyl acrylate, lauryl acrylate, isotridecyl acrylate, octadecyl acrylate, and dodecyl acrylate. Exemplary heteroalkyl acrylates of Formula (II) that can be used to form the B block polymeric unit include, but are not limited to, 2-methoxyethyl acrylate and 2-ethoxy ethyl acrylate.

Some alkyl methacrylates can be used to prepare the B blocks such as alkyl methacrylates having an alkyl group with greater than 6 to 20 carbon atoms. Exemplary alkyl methacrylates include, but are not limited to, 2-ethylhexyl methacrylate, isooctyl methacrylate, n-octyl methacrylate, isodecyl methacrylate, and lauryl methacrylate. Likewise, some heteroalkyl methacrylates such as 2-ethoxy ethyl methacrylate can also be used.

Polymeric units suitable for the B block can be prepared from monomers of Formula (II). (Meth)acrylate monomers that are commercially unavailable or that cannot be polymerized directly can be provided through an esterification or trans-esterification reaction. For example, a (meth)acrylate that is commercially available can be hydrolyzed and then esterified with an alcohol to provide the (meth)acrylate of interest. Alternatively, a higher alkyl (meth)acrylate can be derived from a lower alkyl (meth)acrylate by direct trans-esterification of the lower alkyl (meth)acrylate with a higher alkyl alcohol.

In still other embodiments, the B block polymeric unit is derived from vinyl ester monomers. Exemplary vinyl esters include, but are not limited to, vinyl acetate, vinyl 2-ethyl-hexanoate, and vinyl neodecanoate.

In addition to the monomers described above for the B block, this polymeric unit can be prepared using up to 5 weight percent of the polar monomer such as acrylamide, N-alkyl acrylamide (e.g., N-methyl acrylamide), N,N-dialkyl acrylamide (N,N-dimethyl acrylamide), or hydroxyalkyl acrylate. These polar monomers can be used, for example, to adjust the glass transition temperature, while keeping the T_{g} of the B block less than 20° C. Additionally, these polar monomers can result in polar groups within the polymeric units that can function as reactive sites for chemical or ionic crosslinking, if desired.

The polymeric units can be prepared using up to 4 weight percent, up to 3 weight percent, up to 2 weight percent of the polar monomer. In other embodiments, the B block polymeric unit is free or substantially free of a polar monomer. As used herein, the term “substantially free” in reference to the polar monomer means that any polar monomer that is present is an impurity in one of the selected monomers used to form the B block polymeric unit.

Preferably, the amount of polar monomer is less than 1 weight percent, less than 0.5 weight percent, less than 0.2 weight percent, or less than 0.1 weight percent of the monomers used to form the B block polymeric units.

The B block polymeric unit may be a homopolymer. In some examples of the B block, the polymeric unit can be derived from an alkyl acrylate having an alkyl group with 1 to 22, 2 to 20, 3 to 20, 4 to 20, 4 to 18, 4 to 10, or 4 to 6 carbon atoms. Acrylate monomers such as alkyl acrylate monomers form homopolymers that are generally less rigid than those derived from their alkyl methacrylate counterparts.

Preferably, the composition and respective T_{g} of the A and B blocks provides for a non-tacky single or multilayer film. A single or multilayer film that is non-tacky is advantageous because it is easy to handle and manipulate. This, in turn, facilitates use of the single or multilayer film as a stand-alone layer in manufacturing. Moreover, a non-tacky single or multilayer film also facilitates handling of the reflective film by the end user whenever the single or multilayer film is an exterior layer of the reflective film.

In some single or multilayer film compositions, the block copolymer is an ABA triblock (meth)acrylate block copolymer with an A block polymeric unit derived from a methacrylate monomer and a B block polymeric unit derived from an acrylate monomer. For example, the A block polymeric units can be derived from an alkyl methacrylate monomer and the B block polymer unit can be derived from an alkyl acrylate monomer.

In some more specific examples, the A blocks are derived from an alkyl methacrylate with an alkyl group having 1 to 6, 1 to 4, 1 to 3, or 1 to 2 carbon atoms and the B block is derived from an alkyl acrylate with an alkyl group having 3 to 20, 4 to 20, 4 to 18, 4 to 10, 4 to 6, or 4 carbon atoms. For example, the A blocks can be derived from methyl methacrylate and the B block can be derived from an alkyl acrylate with an alkyl group having 4 to 10, 4 to 6, or 4 carbon atoms.

In a more specific example, the A blocks can be derived from methyl methacrylate and the B block can be derived from n-butyl acrylate. That is, the A blocks are poly(methyl methacrylate) and the B block is poly(n-butyl acrylate).

Optionally, the weight percent of the B block equals or exceeds the weight percent of the A blocks in the block copolymer. Assuming that the A block is a hard block and the B block is a soft block, higher amounts of the A block tend to increase the modulus of the block copolymer. If the amount of the A block is too high, however, the morphology of the block copolymer may be inverted from the desirable arrangement where the B block forms a continuous phase and the block copolymer is an elastomeric material. That is, if the amount of the A block is too high, the copolymer tends to have properties more similar to a thermoplastic material than to an elastomeric material.

Preferably, the block copolymer contains 10 to 50 weight percent of the A block polymeric units and 50 to 90 weight percent of the B block polymeric units. For example, the block copolymer can contain 10 to 40 weight percent of the A block polymeric units and 60 to 90 weight percent of the B block polymeric units, 10 to 35 weight percent of the A block polymeric units and 65 to 90 weight percent of the B block polymeric units, 15 to 50 weight percent of the A block polymeric units and 50 to 85 weight percent of the B block polymeric units, 15 to 35 weight percent of the A block polymeric units and 65 to 85 weight percent of the B block polymeric units, 10 to 30 weight percent of the A block polymeric units and 70 to 90 weight percent of the B block polymeric units, 15 to 30 weight percent of the A block polymeric units and 70 to 85 weight percent of the B block polymeric units, 15 to 25 weight percent of the A block polymeric units and 75 to 85 weight percent of the B block polymeric units, or 10 to 20 weight percent of the A block polymeric units and 80 to 90 weight percent of the B block polymeric units.

The block copolymers can have any suitable molecular weight. In some embodiments, the molecular weight of the block copolymer is at least 2,000 g/mole, at least 3,000 g/mole, at least 5,000 g/mole, at least 10,000 g/mole, at least 15,000 g/mole, at least 20,000 g/mole, at least 25,000 g/mole, at least 30,000 g/mole, at least 40,000 g/mole, or at least 50,000 g/mole. In some embodiments, the molecular weight of the block copolymer is no greater than 500,000 g/mole, no greater than 400,000 g/mole, no greater than 200,000 g/mole, no greater than 100,000 g/mole, no greater than 50,000 g/mole, or no greater than 30,000 g/mole.

For example, the molecular weight of the block copolymer can be in the range of 1,000 to 500,000 g/mole, in the range of 3,000 to 500,000 g/mole, in the range of 5,000 to 100,000 g/mole, in the range of 5,000 to 50,000 g/mole, or in the range of 5,000 to 30,000 g/mole.

The molecular weight is typically expressed as the weight average molecular weight. Any known technique can be used to prepare the block copolymers. In some methods of preparing the block copolymers, iniferters are used as described in European Patent No. EP 349 232 (Andrus et al.). However, for some applications, methods of preparing block copolymers that do not involve the use of iniferters may be preferred because iniferters tend to leave residues that can be problematic especially in photo-induced polymerization reactions.

For example, the presence of thiocarbamate, which is a commonly used iniferter, may cause the resulting block copolymer to be more susceptible to weather-induced degradation. The weather-induced degradation may result from the relatively weak carbon-sulfur link in the thiocarbamate residue. The presence of thiocarbamate can often be detected, for example, using elemental analysis or mass spectroscopy. Thus, in some applications, it is desirable that the block copolymer is prepared using other techniques that do not result in the formation of this weak carbon-sulfur link.

Some suitable methods of making the block copolymers are living polymerization methods. As used herein, the term “living polymerization” refers to polymerization techniques, process, or reactions in which propagating species do not undergo either termination or transfer. If additional monomer is added after 100 percent conversion, further polymerization can occur.

The molecular weight of the living polymer increases linearly as a function of conversion because the number of propagating species does not change. Living polymerization methods include, for example, living free radical polymerization techniques and living anionic polymerization techniques. Specific examples of living free radical polymerization reactions include atom transfer polymerization reactions and reversible addition-fragmentation chain transfer polymerization reactions.

Block copolymers prepared using living polymerization methods tend to have well-controlled blocks. As used herein, the term “well-controlled” in reference to the method of making the blocks and the block copolymers means that the block polymeric units have at least one of the following characteristics: controlled molecular weight, low polydispersity, well-defined blocks, or blocks having high purity. Some blocks and block copolymers have a well-controlled molecular weight that is close to the theoretical molecular weight.

The theoretical molecular weight refers to the calculated molecular weight based on the molar charge of monomers and initiators used to form each block. Well-controlled blocks and block copolymers often have a weight average molecular weight (M_{w}) that is about 0.8 to 1.2 times the theoretical molecular weight or about 0.9 to 1.1 times the theoretical molecular weight. As such, the molecular weight of the blocks and of the total block can be selected and prepared.

Some blocks and block copolymers have low polydispersity. As used herein, the term “polydispersity” is a measure of the molecular weight distribution and refers to the weight average molecular weight (M_{w}) divided by the number average molecular weight (Mₙ) of the polymer. Materials with the same molecular weight have a polydispersity of 1.0 while materials with multiple molecular weights have a polydispersity greater than 1.0. The polydispersity can be determined, for example, using gel permeation chromatography. Well-controlled blocks and block copolymers often have a polydispersity of 2.0 or less, 1.5 or less, or 1.2 or less.

Some block copolymers have well-defined blocks. That is, the boundaries between the A blocks and the continuous phase containing the B blocks are well defined. These well-defined blocks have boundaries that are essentially free of tapered structures. As used herein, the term “tapered structure” refers to a structure derived from monomers used for both the A and B blocks.

Tapered structures can increase mixing of the A block phase and the B block phase leading to decreased overall cohesive strength of the block copolymer or single or multilayer film containing the block copolymer. Block copolymers made using methods such as living anionic polymerization tend to result in boundaries that are free or essentially free of tapered structures.

The distinct boundaries between the A blocks and the B block often results in the formation of physical crosslinks that can increase overall cohesive strength without the need for chemical crosslinks. In contrast to these well-defined blocks, some block copolymers prepared using iniferters have less distinct blocks with tapered structures.

Optionally, the A blocks and B blocks have high purity. For example, the A blocks can be essentially free or free of segments derived from monomers used for the preparation of the B blocks. Similarly, B blocks can be essentially free or free of segments derived from monomers used for the preparation of the A blocks.

Living polymerization techniques typically lead to more stereoregular block structures than blocks prepared using non-living or pseudo-living polymerization techniques (e.g., polymerization reactions that use iniferters). Stereoregularity, as evidenced by highly syndiotactic structures or isotactic structures, tends to result in well-controlled block structures and tends to influence the glass transition temperature of the block.

For example, syndiotactic poly(methyl methacrylate) (PMMA) synthesized using living polymerization techniques can have a glass transition temperature that is about 20° C. to about 25° C. higher than a comparable PMMA synthesized using conventional (i.e., non-living) polymerization techniques. Stereoregularity can be detected, for example, using nuclear magnetic resonance spectroscopy. Structures with greater than about 75 percent stereoregularity can often be obtained using living polymerization techniques.

When living polymerization techniques are used to form a block, the monomers are generally contacted with an initiator in the presence of an inert diluent (or solvent). The inert diluent can facilitate heat transfer and mixing of the initiator with the monomers. Although any suitable inert diluent can be used, saturated hydrocarbons, aromatic hydrocarbons, ethers, esters, ketones, or a combination thereof are often selected.

Exemplary diluents include, but are not limited to, saturated aliphatic and cycloaliphatic hydrocarbons such as hexane, octane, cyclohexane, and the like; aromatic hydrocarbons such as toluene; and aliphatic and cyclic ethers such as dimethyl ether, diethyl ether, tetrahydrofuran, and the like; esters such as ethyl acetate and butyl acetate; and ketones such as acetone, methyl ethyl ketone, and the like.

When the block copolymers are prepared using living anionic polymerization techniques, the simplified structure A-M represents the living A block where M is an initiator fragment selected from a Group I metal such as lithium, sodium, or potassium. For example, the A block can be the polymerization reaction product of a first monomer composition that includes methacrylate monomers of Formula (I). A second monomer composition that includes the monomers used to form the B block can be added to A-M resulting in the formation of the living diblock structure A-B-M. For example, the second monomer composition can include monomers of Formula (II). The addition of another charge of the first monomer composition, which can include monomers of Formula (I), and the subsequent elimination of the living anion site can result in the formation of triblock structure A-B-A. Alternatively, living diblock A-B-M structures can be coupled using difunctional or multifunctional coupling agents to form the triblock structure A-B-A copolymers or (A-B)[n]-star block copolymers.

Any initiator known in the art for living anionic polymerization reactions can be used. Typical initiators include alkali metal hydrocarbons such as organo lithium compounds (e.g., ethyl lithium, n-propyl lithium, iso-propyl lithium, n-butyl lithium, sec-butyl lithium, tert-octyl lithium, n-decyl lithium, phenyl lithium, 2-naphthyl lithium, A-butylphenyl lithium, 4-phenylbutyl lithium, cyclohexyl lithium, and the like). Such initiators can be useful in the preparation of living A blocks or living B blocks.

For living anionic polymerization of (meth)acrylates, the reactivity of the anion can be tempered by the addition of complexing ligands selected from materials such as crown ethers, or lithium ethoxylates. Suitable difunctional initiators for living anionic polymerization reactions include, but are not limited to, 1,1,4,4-tetraphenyl-1,4-dilithiobutane; 1,1,4,4-tetraphenyl-1,4-dilithioisobutane; and naphthalene lithium, naphthalene sodium, naphthalene potassium, and homologues thereof.

Other suitable difunctional initiators include dilithium compounds such as those prepared by an addition reaction of an alkyl lithium with a divinyl compound. For example, an alkyl lithium can be reacted with 1,3-bis(1-phenylethenyl)benzene or m-diisopropenylbenzene.

For living anionic polymerization reactions, it is usually advisable to add the initiator in small quantities (e.g., a drop at a time) to the monomers until the persistence of the characteristic color associated with the anion of the initiator is observed. Then, the calculated amount of the initiator can be added to produce a polymer of the desired molecular weight. The preliminary addition of small quantities often destroys contaminants that react with the initiator and allows better control of the polymerization reaction.

The polymerization temperature used depends on the monomers being polymerized and on the type of polymerization technique used. Generally, the reaction can be carried out at a temperature of about −100° C. to about 150° C. For living anionic polymerization reactions, the temperature is often about −80° C. to about 20° C. For living free radical polymerization reactions, the temperature is often about 20° C. to about 150° C. Living free radical polymerization reactions tend to be less sensitive to temperature variations than living anionic polymerization reactions.

Methods of preparing block copolymers using living anionic polymerization methods are further described, for example, in U.S. Pat. No. 6,734,256 (Everaerts etal), U.S. Pat. No. 7,084,209 (Everaerts et al), U.S. Pat. No. 6,806,320 (Everaerts et al), and U.S. Pat. No. 7,255,920 (Everaerts et al.). This polymerization method is further described, for example, in U.S. Pat. No. 6,630,554 (Hamada et al.) and U.S. Pat. No. 6,984,114 (Kato et al.) as well as in Japanese Patent Application Kokai Publication Nos. Hei 11-302617 (Uchiumi et al.) and 11-323072 (Uchiumi et al.)

In general, the polymerization reaction is carried out under controlled conditions so as to exclude substances that can destroy the initiator or living anion. Typically, the polymerization reaction is carried out in an inert atmosphere such as nitrogen, argon, helium, or combinations thereof. When the reaction is a living anionic polymerization, anhydrous conditions may be necessary.

Suitable block copolymers can be purchased from Kuraray Co., LTD. (Tokyo, Japan) under the trade designation LA POLYMER. Some of these block copolymers are triblock copolymers with poly(methyl methacrylate) endblocks and a poly(n-butyl acrylate) midblock. In some embodiments, more than one block copolymer is included in the single or multilayer film composition. For example, multiple block copolymers with different weight average molecular weights or multiple block copolymers with different block compositions can be used.

The use of multiple block copolymers with different weight average molecular weights or with different amounts of the A block polymeric units can, for example, improve the shear strength of the single or multilayer film composition.

If multiple block copolymers with different weight average molecular weights are included in the single or multilayer film composition, the weight average molecular weights can vary by any suitable amount. In some instances, the molecular weights of a first block copolymer can vary by at least 25 percent, at least 50 percent, at least 75 percent, at least 100 percent, at least 150 percent, or at least 200 percent from a second block copolymer having a larger weight average molecular weight.

The block copolymer mixture can contain 10 to 90 weight percent of a first block copolymer and 10 to 90 weight percent of a second block copolymer having a larger weight average molecular weight, 20 to 80 weight percent of the first block copolymer and 20 to 80 weight percent of the second block copolymer having the larger weight average molecular weight, or 25 to 75 weight percent of the first block copolymer and 25 to 75 weight percent of the second block copolymer having the larger weight average molecular weight.

If multiple block copolymers with different concentrations of the A block polymeric units are included in the single or multilayer film composition, the concentrations can differ by any suitable amount. In some instances, the concentration can vary by at least 20 percent, at least 40 percent, at least 60 percent, at least 80 percent, or at least 100 percent. The block copolymer mixture can contain 10 to 90 weight percent of a first block copolymer and 10 to 90 weight percent of a second block copolymer having a greater amount of the A block or 20 to 80 weight percent of the first block copolymer and 20 to 80 weight percent of the second block copolymer having the greater amount of the A block or 25 to 75 weight percent of the first block copolymer and 25 to 75 weight percent of the second block copolymer having the greater amount of the A block.

In additional exemplary embodiments of any of the foregoing, the first block copolymer is included in the film in an amount from 5 wt. % to 75 wt. % based on the total weight of poly(methyl methacrylate) if present, the poly(vinylidene fluoride), and the first block copolymer in the film. In additional exemplary embodiments of any of the foregoing, the single or multilayer film further includes at least one additional block copolymer having endblocks including poly(methyl methacrylate) and a midblock including poly(butyl acrylate), wherein the at least one additional block copolymer is compositionally distinct from the first block copolymer.

In some exemplary embodiments, the single 100 or multilayer film 100′-100″ comprises a triblock copolymer that is non-tacky (non-adhesive) at ambient temperatures. The block copolymer has at least two endblock polymeric units, each derived from a first monoethylenically unsaturated monomer comprising a methacrylate, acrylate, styrene, or combination thereof. The block copolymer has one midblock polymeric unit that is derived from a second monoethylenically unsaturated monomer comprising a methacrylate, acrylate, vinyl ester, or combination thereof. Each endblock has a glass transition temperature of at least 50° C., while the midblock has a glass transition temperature no greater than 20° C.

The single 100 or multilayer film 100′-100″ may alternatively comprise a block copolymer/homopolymer blend. For example, the single 100 or multilayer film 100′-100″ may include an A-B-A triblock copolymer blended with a homopolymer that is soluble in either the A or B block. Optionally, the homopolymer has a polymeric unit identical to either the A or B block. The addition of one or more homopolymers to the block copolymer composition can be advantageously used either to plasticize or to harden one or both blocks. In preferred embodiments, the block copolymer contains a poly(methyl methacrylate) A block and a poly(butyl acrylate) B block, and is blended with a poly(methyl methacrylate) homopolymer.

Advantageously, blending poly(methyl methacrylate) homopolymer with poly(methyl methacrylate)-poly(butyl acrylate) block copolymers allows the hardness of the single 100 or multilayer film 100′-100″ to be tailored to the desired application. As a further advantage, blending with poly(methyl methacrylate) provides this control over hardness without significantly degrading the clarity or processibility of the overall composition. Preferably, the homopolymer/block copolymer blend has an overall poly(methyl methacrylate) composition of at least 30 percent, at least 40 percent, or at least 50 percent, based on the overall weight of the blend. Preferably, the homopolymer/block copolymer blend has an overall poly(methyl methacrylate) composition no greater than 95 percent, no greater than 90 percent, or no greater than 80 percent, based on the overall weight of the blend.

Particularly suitable non-tacky block copolymers include poly(methyl methacrylate)-poly(n-butyl acrylate)-poly(methyl methacrylate) (25:50:25) triblock copolymers. These materials were previously available under the trade designation LA POLYMER from Kuraray Co., LTD, and are available as of the filing date of this application under the brand name KURARITY from the same company, as of August 2010.

Optionally, the block copolymer may be combined with a suitable ultraviolet light absorber to enhance the stability of the single 100 or multilayer film 100′-100″. In some embodiments, the block copolymer contains an ultraviolet light absorber. In some embodiments, the block copolymer contains an amount of the ultraviolet light absorber ranging from 0.5 percent to 3.0 percent by weight, based on the total weight of the block copolymer and absorber. It is to be noted, however, that the block copolymer need not contain any ultraviolet light absorbers. Using a composition free of any ultraviolet light absorbers can be advantageous because these absorbers can segregate to the surfaces of the single 100 or multilayer film 100′-100″ and interfere with adhesion to adjacent layers.

As a further option, the block copolymer may be combined with one or more nanofillers to adjust the modulus of the single 100 or multilayer film 100′-100″. For example, a nanofiller such as silicon dioxide or zirconium dioxide can be uniformly dispersed in the block copolymer to increase the overall stiffness or hardness of the article 100. In preferred embodiments, the nanofiller is surface-modified as to be compatible with the polymer matrix. This can help avoid making porous materials that scatter light upon tentering.

The single 100 or multilayer film 100′-100″ may also comprise a random copolymer having a first polymeric unit with a relatively high T_{g} and second polymeric unit with a relatively low T_{g}. In this embodiment, the first polymeric unit derives from a first monoethylenically unsaturated monomer comprising a methacrylate, acrylate, styrene, or combination thereof and associated with a glass transition temperature of at least 50° C. and the second polymeric unit derived from a second monoethylenically unsaturated monomer comprising a methacrylate, acrylate, vinyl ester, or combination thereof and associated with a glass transition temperature no greater than 20° C.

In particularly preferred random copolymers, the first polymeric unit is methyl methacrylate and the second polymeric unit is butyl acrylate. It is preferable that the random copolymer has a methyl methacrylate composition of at least 50 percent, at least 60 percent, at least 70 percent, or at least 80 percent, based on the overall weight of the random copolymer. It is further preferable that the random copolymer has a methyl methacrylate composition of at most 80 percent, at most 85 percent, at most 90 percent, or at most 95 percent, based on the overall weight of the random copolymer.

In some embodiments, the single 100 or multilayer film 100′-100″ has a thickness of at least 10 micrometers, at least 50 micrometers, or at least 60 micrometers. Additionally, in some embodiments, the single 100 or multilayer film 100′-100″ has a thickness no greater than 200 micrometers, no greater than 150 micrometers or no greater than 100 micrometers.

Optionally but not shown, the single 100 or multilayer film 100′-100″ may be adhered to a supporting substrate (or back plate) to impart a suitable shape to the single 100 or multilayer film 100′-100″. Article 100 can be adhered to a substrate using, for example, a suitable adhesive. In some embodiments, the adhesive is a pressure sensitive adhesive. As used herein, the term “pressure sensitive adhesive” refers to an adhesive that exhibits aggressive and persistent tack, adhesion to a substrate with no more than finger pressure, and sufficient cohesive strength to be removable from the substrate. Exemplary pressure sensitive adhesives include those described in PCT Publication No. WO 2009/146227 (Joseph, et al.).

### Optional Copolymer Film Components

### Poly(Methyl Methacrylate)

Optionally, in additional exemplary embodiments of any of the foregoing films, poly(methyl methacrylate) is included in the film in an amount from 1 wt. % to 55 wt. % based on the total weight of the poly(methyl methacrylate), the poly(vinylidene fluoride), and the first block copolymer in the film.

### (Meth)Acrylate COPOLYMER

In additional exemplary embodiments of any of the foregoing films, the film further comprises a (meth)acrylate (co)polymer derived by radiation curing one or more radiation-curable (meth)acrylic monomers. In certain such exemplary embodiments, the (meth)acrylate (co)polymer is included in the film in an amount from 10 wt. % to 90 wt. % based on the total weight of any poly(methyl methacrylate), the poly(vinylidene fluoride), and the first block copolymer included in the film. In some exemplary multilayer film embodiments, the first outer layer includes a blend of the poly(methyl methacrylate), the poly(vinylidene fluoride), and the (meth)acrylate (co)polymer, and the second outer layer includes the first block copolymer. In other such exemplary multilayer film embodiments, the first outer layer includes a blend of the poly(methyl methacrylate) and the (meth)acrylate (co)polymer, and the second outer layer includes a blend of the poly(vinylidene fluoride) and the first block copolymer. In additional exemplary multilayer film embodiments, the first outer layer includes a blend of the (meth)acrylate (co)polymer and a portion of the poly(methyl methacrylate), and the second outer layer comprises a blend of the poly(vinylidene fluoride), the first block copolymer, and a remaining portion of the (meth)acrylate (co)polymer not included in the first outer layer.

### Random Copolymers

In some exemplary embodiments, the copolymer films include at least one random copolymer. As used herein, the term “random copolymer” refers to a polymeric material that includes at least two different polymeric units (or repeat units) that are covalently bonded to each other in a randomized fashion along the polymer backbone. Like block copolymers, random copolymers include two or more polymeric units that are chemically dissimilar. Moreover, the polymeric units of random copolymers are derived from two or more respective monoethylenically unsaturated monomers, and are associated with different respective glass transition temperatures. However, unlike block copolymers, random copolymers have polymeric units that are not segregated into discrete blocks, but rather homogenously interspersed with each other on a nanoscopic level.

Random copolymers also differ from block copolymers in their macroscopic properties. While block copolymers can microphase separate based on the insolubility of the A and B blocks, random copolymers have a homogenous microstructure. As a result, random copolymers display only a single glass transition temperature, while microphase-separated block copolymers display two or more glass transition temperatures.

The glass transition temperature of a random copolymer generally resides between the glass transition temperatures associated with its respective polymeric units. For example, a random copolymer of methyl methacrylate and n-butyl acrylate has a glass transition temperature residing between that of the corresponding poly(methyl methacrylate) and poly(n-butyl acrylate) homopolymers. If desired, the exact glass transition temperature can be approximated using various theoretical and empirical formulas based on the glass transition temperatures associated with the polymeric units and the relative weight or volume fraction of each component.

The random copolymers described herein include at least a first polymeric unit A and a second polymeric unit B. The A polymeric unit is the “hard,” rigid component, while the B polymeric unit is the “soft,” less rigid component. The A polymeric unit, when reacted to form a homopolymer, has a glass transition temperature of at least 50° C. The B polymeric unit, when reacted to form a homopolymer, has a glass transition temperature no greater than 20° C. In other words, the A polymeric unit is associated with a glass transition temperature of at least 50° C., while the B polymeric unit is associated with a glass transition temperature no greater than 20° C.

In exemplary random copolymers, the A polymeric unit is associated with a glass transition temperature of at least 60° C., at least 80° C., at least 100° C., or at least 120° C., while the B polymeric unit is associated with a glass transition temperature no greater than 10° C., no greater then 0° C., no greater than −5° C., or no greater than −10° C.

The A polymeric units are generally associated with homopolymers that are thermoplastic materials, while the B polymeric units are generally associated with homopolymers that are elastomeric materials. Further, the solubility parameters associated with the A and B polymeric units are sufficiently different that the respective A and B homopolymers would not be miscible in each other. As a result of its randomized polymer architecture, however, the random copolymer exhibits a homogenous microstructure at all compositions.

Exemplary chemical structures and characteristics of the A and B polymeric units are similar to those previously described for the A block and B block polymeric units, and thus shall not be repeated here.

The weight percent of the A polymeric units generally exceeds the weight percent of the B polymeric units in the random copolymer. Higher amounts of the A polymeric unit tends to increase the overall modulus of the random copolymer. At the same time, higher amounts of the A polymeric block also tends to reduce the tackiness of the random copolymer at ambient temperatures. The single or multilayer film including the random copolymer may be either tacky or non-tacky. However, it is preferable that the single or multilayer film is non-tacky for the same reasons given before concerning single or multilayer films that include block copolymers.

The random copolymer typically contains 60 to 95 weight percent of the A polymeric units and 5 to 40 weight percent of the B polymeric units. For example, the block copolymer can contain 60 to 90 weight percent of the A polymeric units and 10 to 40 weight percent of the B polymeric units, 60 to 85 weight percent of the A polymeric units and 15 to 40 weight percent of the B polymeric units, 65 to 95 weight percent of the A polymeric units and 5 to 35 weight percent of the B polymeric units, 65 to 90 weight percent of the A polymeric units and 10 to 35 weight percent of the B polymeric units, 65 to 85 weight percent of the A polymeric units and 15 to 35 weight percent of the B polymeric units, 70 to 95 weight percent of the A polymeric units and 5 to 30 weight percent of the B polymeric units, 70 to 90 weight percent of the A polymeric units and 10 to 20 weight percent of the B polymeric units, or 70 to 85 weight percent of the A polymeric units and 15 to 30 weight percent of the B polymeric units.

Like the block copolymers described previously, the random copolymers can have any suitable molecular weight. Exemplary molecular weights have already been enumerated in detail for block copolymers and similarly apply here for random copolymers. Additionally, random copolymers having low polydispersity are also contemplated. In preferred embodiments, the random copolymer has a polydispersity of 2.0 or less, 1.5 or less, or 1.2 or less.

Suitable methods of making the random copolymers include living polymerization methods, including the living anionic and living free radical polymerization techniques previously described. While the synthesis of block copolymers generally involves sequential addition of the A and B monomers, however, the synthesis of random copolymers generally involves adding the initiator to a stirred solution containing both the A and B monomers or simultaneously introducing both the A and B monomers into a stirred solution of the initiator. Advantageously, these methods tend to produce random copolymers with controlled molecular weight, low polydispersity, and/or high purity. Conventional, non-living, free-radical polymerization techniques may also be used to prepare the random copolymers. Suitable random copolymers are also commercially available from Dow Chemical Company (Midland, Mich.), BASF SE (Ludwigshafen, Germany), and The Polymer Source, Inc. (Montreal, Canada).

In some embodiments, two or more random copolymers may be included in the single or multilayer film compositions described herein. For example, random copolymers having different weight average molecular weights or different compositions of the A and B polymeric units may be used. Optionally, the two or more random copolymers are present as discrete layers within in the single or multilayer film. Alternatively, the two or more random copolymers are blended together to provide a homogenous microstructure. If a blend is contemplated, it is preferable that any differences in composition are not so large that the copolymers phase separate from each other. Advantageously, a combination of two or more random copolymers can be used to tailor the shear strength of the single or multilayer film composition.

In some embodiments, the differences in molecular weight and/or differences in composition of the two or more random copolymers are similar to those previously enumerated with respect to block copolymers. As such, this description shall not be repeated here.

### Ultraviolet Light Absorbers and Hindered Amine Light Stabilizers

Overall, the copolymer film is capable, in some exemplary embodiments, of providing high hardness and weatherability, excellent coatability (or sticking coefficient), and vacuum ultraviolet radiation stability. In certain exemplary embodiments, additives such as ultraviolet stabilizers, hindered amine light stabilizers (HALS), antioxidants and the like are included in the single layer film 100 or in one or both of the outer layers 102′ and 102″ of a dual layer 100′ or multilayer 100″ film. Preferably, the at least one interior layer 108 having a composition 103 is kept substantially free of these additives to avoid adhesion issues that could arise from segregation of ultraviolet stabilizers, HALS, antioxidants and other additives to the surface to be coated.

Thus, in some exemplary embodiments of any of the foregoing films, the film further includes at least one ultraviolet (UV) light absorber in an amount from 0.1 wt. % to 10 wt. %. In certain such exemplary embodiments, the film further includes at least one hindered amine light stabilizer (HALS) in an amount from 0.1 wt. % to 1 wt. %. Optionally, the UV light absorber is present in an amount from 0.5 wt. % to 5 wt. %.

In some exemplary dual 100′ or multilayer 100″ film embodiments, one or both of the outer layers 102′ and 102″ is comprised of poly(methyl methacrylate) and contains an amount of an ultraviolet light absorber ranging from 0.5 percent to 3.0 percent by weight, based on the total weight of the poly(methyl methacrylate) and absorber.

### Nanoparticulates

In additional exemplary embodiments of any of the foregoing films, the film further includes a multiplicity of inorganic nanoparticulates having a median particle diameter of less than one micrometer. In some such exemplary embodiments, the inorganic nanoparticulates are metal oxide particulates selected from titanium dioxide, aluminum oxide, silicon dioxide, indium oxide, tin oxide, zinc oxide, zirconium oxide, and combinations thereof. The inorganic nanoparticulates may be distributed, preferably homogeneously distributed, throughout a single layer film 100, or included in one, any or all of the outer layers 102′ and 102″ of a dual layer 100′ or multilayer 100″ film, and/or in any interior layer 108 having a composition 103 of a multilayer 100″ film.

### Methods

In a further aspect, the disclosure discloses methods of making any of the foregoing films, the method including providing a molten poly(vinylidene fluoride), providing a molten block copolymer having at least two endblock polymeric units that are each derived from a first monoethylenically unsaturated monomer comprising a methacrylate, acrylate, styrene, or combination thereof, wherein each endblock has a glass transition temperature of at least 50° C.; and at least one midblock polymeric unit that is derived from a second monoethylenically unsaturated monomer comprising a methacrylate, acrylate, vinyl ester, or combination thereof, wherein each midblock has a glass transition temperature no greater than 20° C., passing the molten poly(vinylidene fluoride) and the molten block copolymer through a film extrusion die; and after exiting the film extrusion die, cooling the molten poly(vinylidene fluoride) and the molten block copolymer to a temperature of about room temperature (i.e. 23.0+/−3.4° C.) to form the film.

In some exemplary embodiments, the method further includes providing a molten poly(methyl methacrylate), passing the molten poly(methyl methacrylate) through a film extrusion die, optionally wherein passing the molten poly(methyl methacrylate) through the film extrusion die is simultaneous with passing the molten poly(vinylidene fluoride) and the molten block copolymer through the film extrusion die, and after exiting the film extrusion die, cooling the molten poly(methyl methacrylate) to a temperature of about room temperature.

In some exemplary embodiments of any of the foregoing, the film is a multilayer film including a first outer layer and a second outer layer opposite said first outer layer. In certain such exemplary multilayer film embodiments, the first outer layer includes a blend of the poly(methyl methacrylate), the poly(vinylidene fluoride), and the (meth)acrylate (co)polymer, and the second outer layer includes the first block copolymer. In other exemplary multilayer film embodiments, the first outer layer includes a blend of the poly(methyl methacrylate) and the (meth)acrylate (co)polymer, and the second outer layer includes a blend of the poly(vinylidene fluoride) and the first block copolymer. In additional exemplary multilayer film embodiments, the first outer layer includes a blend of the (meth)acrylate (co)polymer and a portion of the poly(methyl methacrylate), and the second outer layer includes a blend of the poly(vinylidene fluoride), the first block copolymer, and the remaining portion of the (meth)acrylate (co)polymer not included in the first outer layer. In some exemplary multilayer film embodiments, the film includes at least one interior layer between the first and second outer layers.

Exemplary films of the present disclosure may be prepared, for example, using the apparatus and methods disclosed in U.S. Pat. No. 6,783,349, entitled “Apparatus for Making Multilayer Optical Films” and U.S. Pat. No. 6,827,886, entitled “Method for Making Multilayer Optical Films”. Examples of additional layers or coatings suitable for use with exemplary films of the present disclosure are described in U.S. Pat. Nos. 6,368,699, and 6,459,514 both entitled “Multilayer Polymer Film with Additional Coatings or Layers”.

### Articles and Unexpected Results and Advantages

The disclosure also provides articles comprising any of the foregoing films. In certain such exemplary embodiments, the article is selected from an organic light emitting display, a lighting element, a solar reflector, a photovoltaic cell, a mirror, a window, a graphic arts display, a sign, or a combination thereof.

Preferably, the foregoing films and/or articles are visible light-transmissive or optically clear, exhibiting, in some exemplary embodiments, an average radiation transmission over the visible light portion of the radiation spectrum from 380 nm to 780 nm (Tᵥᵢₛ) of at least about 90%, measured along the normal axis. Additionally and more preferably, in some exemplary embodiments the foregoing films exhibit an average radiation transmission of at least 90% over the solar radiation wavelength range from 380 nm to 3,000 nm (Tₛₒₗₐᵣ).

The exemplary films and articles of the present disclosure, in some exemplary embodiments, advantageously provide high optical transmissivity and low haze and yellowing, good weatherability, good abrasion, scratch and crack resistance during to handling and cleaning, and good adhesion to other layers, for example, other (co)polymer layers, metal oxide layers, and metal layers applied to one or both major surfaces of the films when used as substrates, for example, in compact electronic display and/or solar energy applications.

While not wishing to be bound by any particular theory, it is presently believed that in a high vacuum process such as physical vapor deposition, vacuum ultraviolet radiation (having wavelengths below 165 nanometers) can induce chain scission at the surface of a poly(methyl methacrylate) top layer. This chain scission can, in turn, adversely affect the ability of the poly(methyl methacrylate) to adhere to adjacent metal layers deposited using such a process. In some exemplary embodiments, the single 100, dual 100′ or multilayer film 100″ can advantageously protect a poly(methyl methacrylate) surface. Since the film is less susceptible to chain scission, it can insulate the poly(methyl methacrylate) surface from the damaging effects of vacuum ultraviolet radiation.

The single or multilayer film 302 may provide, in some exemplary embodiments, additional benefits that promote adhesion during environmental exposure to temperature and humidity fluctuations. The rubbery B block permits diffusion of stress due to differential expansion in the stack associated with changes in temperature and humidity. Additionally, the disclosed block and random copolymers are also substantially less water permeable than poly(methyl methacrylate). Water adsorption can result in chemical or physical reduction in adhesive contact between the metal and adjacent polymer layer.

Exemplary embodiments of copolymeric films and methods of making and using such films have been described above and are further illustrated below by way of the following Examples, which are not to be construed in any way as imposing limitations upon the scope of the present invention. On the contrary, it is to be clearly understood that resort may be had to various other embodiments, modifications, and equivalents thereof which, after reading the description herein, may suggest themselves to those skilled in the art without departing from the spirit of the present disclosure and/or the scope of the appended claims.

### EXAMPLES

These examples are merely for illustrative purposes and are not meant to be limiting on the scope of the appended claims. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Materials

The materials listed in Table 1 were used in carrying out the Examples. Solvents and other reagents used in the Examples may be obtained from Sigma-Aldrich Chemical Company (Milwaukee, Wis.) unless otherwise noted. All parts, percentages, ratios, and the like in the examples and the rest of the specification are by weight, unless noted otherwise.

TABLE 1
Materials

| Material | Supplier |
|---|---|
| Poly(methyl methacrylate) (PMMA) | Plaskolite, Inc., Columbus, OH |
| resin CP-80 | |
| Block copolymer (PnBA) | Kuraray Co., Ltd., Tokyo, Japan |
| LA 4285 | |
| LAF820 (80:20 w/w mix of LA4285 | |
| and PMMA) | |
| Poly(vinylidene fluoride) | 3M Dyneon, St. Paul, MN |
| PVDF 6008 (Resin) | |
| PVDF Film (Kynar) | Professional Plastic.com |

### Test Methods

### Optical Clarity (Light Transmission and Haze)

Representative samples were visually inspected by holding them against a light source (100 watts, incandescent light bulb from Sylvania Inc) and looking at the transmitted light intensity to determine their Optical Clarity ranking.

A BYK-GARDNER HAZE-GARD PLUS haze meter (BYK-GARDNER USA, Inc., Columbia, Md.) was also used to measure light transmission and haze of the pressed film samples.

### Tape Adhesion

Adhesion of metal to the copolymer film was tested by simple tape test method using MAGIC TAPE (Catalogue #810) available from 3M Company, St. Paul, Minn. A 5″ long piece of ½″ wide magic tape was adhered to the metal side of the sample with the help of a hand roller leaving a small tab on the end to use as a handle for peeling. Good contact of tape adhesive with metal was ensured by removing any air bubbles trapped between metal and tape. Tape was pulled of the sample manually at a high angle (150 to 180 degrees) and slow pull rate (˜1 ft/min) in one single motion. The film sample and tape both were examined for metal removal and calculated percentage of the metal area removed was used as the criterion for sample rankings

### Film Brittleness Testing

Samples were tested by manually folding (by 180 degrees) the film on each side in the vertical and horizontal axis-directions. Samples that shattered or broke three out of four times were given ranking of 5, and samples that never broke were given rating of 1.

### Copolymer Film Preparation

### Comparative Example 1 (CE 1)

A 3.5 mil extruded and bi-axially stretched PMMA film (internal 3M Company) was used to create a control sample. To test adhesion properties of the PMMA, multiple 12″×10″ sheets were metalized (Silver) in high vacuum physical vapor deposition (PVD) coater. Before depositing silver laer an additional 5 nm thick TiO₂ tie layer was deposited to improve the adhesion. Up to six specimens were loaded at a time, in the rotating dome of a PVD batch coater (Denton Inc), on six 12 inch (30.5 cm) diameter specimen holders, which were located near the edge of the dome and configured at 45 degree angles facing the point source at the base plate of the coater. The point source had 4 pocket electron beam (e-beam) crucibles, each of 1.5 inch (3.8 cm) diameter.

As is common for PVD coaters of this type, the coating dome was rotated on its central axis and each holder was also rotated on its individual central axis. This double rotation served to ensure uniform deposition of metal and metal oxides vapors from the hot point source. Once the specimens were loaded, the coater was evacuated, first using a mechanical roughing pump and then using a cryogenic pump to reduce pressure to one millionth of a torr. At this pressure, the electron beam gun was turned on to pre-heat TiO₂ pellets in the first of the four crucibles. When an appropriate vapor pressure of TiO₂ was achieved, the shield between the heated crucible and the specimen holders was removed, allowing TiO₂ vapors to deposit on the rotating specimens. A 5 nm thick TiO₂ film was deposited, at the rate of 5 Angstroms/second, on the surface of the specimens. The rate of deposition and the thickness was measured using an INFICON brand crystal rate/thickness monitoring sensor and controller (Inficon, East Syracuse, N.Y.).

After depositing 5 nm of TiO₂, the shield was automatically closed by the thickness monitoring system to completely stop vapors from reaching the specimens. Without breaking vacuum, the second crucible, holding 99.999% purity silver wire pieces, was moved in to place. The same procedure as that for TiO₂ deposition was repeated to deposit a 90 nm thick silver layer over the TiO₂ layer. Then a third crucible holding copper wire was moved into place, and a 30 nm thick copper layer was deposited over the silver layer. Finally, the coater was backfilled slowly with dry nitrogen, and the specimens were carefully removed.

After coating the specimen, adhesion of deposited metal layer to PMMA was tested using a standard tape peel test as described in the test methods. Adhesion results are given in Table 2.

### Comparative Example 2 (CE2)

Same as CE1 except a 10 mil PVDF (Trade name-Kynar) film available commercially from ProfessionalPlastic.com was used as substrate instead of PMMA.

### Comparative Example 3 (CE3)

Same as CE1 except a 4 mil PnBA (Trade name-LA 4285) film commercially available from Kuraray Inc was used as substrate instead of PMMA.

### Example 1

The polymers blend was pre-mixed by weighing out approximately 30 g of the three polymer resins, PVDF, PMMA, and PnBA (LA4285), in a ratio of 27% PVDF/49% PnBA/24% PMMA. The resin blend was pushed into the feed port of a twin screw micro-compounder (manufactured by DSM Xplore) set at a processing temperature of 210° C., screw speed of 126 rpm, and a mixing force of 1,000N. The sample was allowed to mix in the barrel of the compounder for five minutes and than extruded out of a port as paste. Once the blended material has cooled down to room temperature a small portion of it (˜1.0 gram) was placed between two optically smooth chrome plated SS plates and pressed into a thin sheet in a hydraulic press. Comparative ratings of the Optical Clarity are listed in the Table 2.

### Example 2

Same as Example 1 except the ratio of PVDF:PnBA:PMMA was changed to 25:75:0.

### Example 3

Same as Example 1 except the ratio of PVDF:PnBA:PMMA was changed to 17:42:41.

### Example 4

LAF820:PVDF resins were premixed in a container by hand stirring and shaking in the 50:50 ratio. This premixed resin blend was slowly fed in to a small conical twin screw hot melt extruder (Brabender PL2000 Plasti-Corder) with multiple independently controlled hot zones. Each of the three zones starting with the feeding port to the extrusion die were set at 350 F, 450 F and 490 F. Resin was fed into the extruder at the rate of 6 lb/hr and screw speed was set at 110 RPM to achieve optimum mixing and melting of the polymers. Polymer melt temperature was recorded at 459 F via an integrated thermocouple. Blended polymer melt was extruded from a single slot die at 114 PSI pressure on to a casting roll with adjustable speed to control the stretching and extrusion of the film to desired thickness. Casting roller's temperature was maintained at 80 F and web speed was set at 40 ft/min. A stainless steel pinch roller was available but it was not used. Haze and transmission values were measured using a Haze-Gard Plus instrument (BYK-Gardner, Inc.) and results are listed in Table 2.

### Example 5

Same as Example 4 except the ratio and composition of PnBA/PMMA/PVDF was set at 35:15:50 respectively.

### Example 6

Same as Example 4 except the blend composition was LAF820/PVDF was set at 60:40 respectively.

TABLE 2
PVDF, PnBA, PMMA Blend Films: Clarity and Adhesion

| | | Press | | | |
|---|---|---|---|---|---|
| | | Temper- | Clarity | Adhesion | Brit- |
| | PVDF/ | ature | Rank | (% | tleness |
| Example | PnBA/PMMA | (° F.) | (1 = Best) | Removed) | Ranking |
| CE1 | PMMA 100% | NA | 1 | 100% | 5 |
| CE2 | PVDF 100% | NA | 1 | 100% | 1 |
| CE3 | PnBA 100% | NA | 1 | 0% | 1 |
| Example 1 | 27/49/24 | 425 | 2 | <5% | 1 |
| Example 2 | 25/75/0 | 425 | 3 | <5% | 1 |
| Example 3 | 17/42/41 | 425 | 4 | <10% | 1 |

TABLE 3
PVDF, PnBA, PMMA Blend Films: Light Transmission and Haze

| | | Transmission | Haze/Thickness |
|---|---|---|---|
| Example | Sample Description | (%) | (mil⁻¹) |
| CE1 | 3.5 mil PMMA | 94.4 | 0.1 |
| Example 4 | 50% LAF820/50% PVDF | 94 | 0.2 |
| Example 5 | 35% PnBA/15% PMMA/ | 95 | 0.5 |
| | 50% PVDF | | |
| Example 6 | 60% LAF820/40% PVDF | 94.7 | 0.6 |

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, all publications, published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following listing of disclosed embodiments.

1. A film comprising:
poly(vinylidene fluoride), and
a first block copolymer with at least two endblock polymeric units that are each derived from a first monoethylenically unsaturated monomer comprising a methacrylate, acrylate, styrene, or combination thereof, wherein each endblock has a glass transition temperature of at least 50° C.; and at least one midblock polymeric unit that is derived from a second monoethylenically unsaturated monomer comprising a methacrylate, acrylate, vinyl ester, or combination thereof, wherein each midblock has a glass transition temperature no greater than 20° C., optionally further comprising poly(methyl methacrylate).

2. (canceled)

3. The film of claim 1, wherein the film is comprised of a first outer layer and a second outer layer opposite said first outer layer.

4. The film of claim 2, wherein each of the first outer layer and the second outer layer has a thickness of from 0.1 micrometer to 250 micrometers.

5. The film of claim 3, wherein the film is comprised of at least one interior layer between said first and second outer layers.

6. (canceled)

7. The film of claim 5, wherein the at least one interior layer comprises a plurality of interior layers.

8. (canceled)

9. The film of claim 1 further comprising poly(methyl methacrylate), wherein the first outer layer is adjacent to the second outer layer, optionally wherein the first and second outer layers each have a thickness of from 0.1 micrometer to 500 micrometers.

10. (canceled)

11. The film of any one of claim 1, further comprising a (meth)acrylate (co)polymer derived by radiation curing one or more radiation-curable (meth)acrylic monomers, optionally wherein the (meth)acrylate (co)polymer is included in the film in an amount from 10 wt. % to 90 wt. % based on the total weight of the poly(methyl methacrylate), the poly(vinylidene fluoride), and the first block copolymer in the film.

12. (canceled)

13. The film of claim 11, wherein the first outer layer comprises a blend of the poly(methyl methacrylate), the poly(vinylidene fluoride), and the (meth)acrylate (co)polymer, and further wherein the second outer layer comprises the first block copolymer, or wherein the first outer layer comprises a blend of the poly(methyl methacrylate) and the (meth)acrylate (co)polymer, and further wherein the second outer layer comprises a blend of the poly(vinylidene fluoride) and the first block copolymer, or wherein the first outer layer comprises a blend of the (meth)acrylate (co)polymer and a portion of the poly(methyl methacrylate), and further wherein the second outer layer comprises a blend of the poly(vinylidene fluoride), the first block copolymer, and a remaining portion of the (meth)acrylate (co)polymer not included in the first outer layer.

14. (canceled)

15. (canceled)

16. The film of claim 1, wherein each endblock comprises poly(methyl methacrylate) and each midblock comprises poly(butyl acrylate).

17. The film of claim 1, wherein the first block copolymer comprises from 30 wt. % to 80 wt. % endblocks, and from 20 wt. % to 70 wt. % midblocks, based on a total weight of the first block copolymer.

18. The film of claim 1, wherein the first block copolymer comprises from 50 wt. % to 70 wt. % endblocks, and from 30 wt. % to 50 wt. % midblocks, based on the total weight of the first block copolymer.

19. The film of any one of claim 1, wherein the poly(methyl methacrylate) is included in the film in an amount from 1 wt. % to 55 wt. % to based on the total weight of the poly(methyl methacrylate), the poly(vinylidene fluoride), and the first block copolymer in the film.

20. The film of claim 1, wherein the poly(vinylidene fluoride) is included in the film in an amount from 5 wt. % to 75 wt. % based on the total weight of poly(methyl methacrylate) if present, the poly(vinylidene fluoride), and the first block copolymer in the film.

21. The film of claim 1, wherein the first block copolymer is included in the film in an amount from 5 wt. % to 75 wt. % based on the total weight of poly(methyl methacrylate) if present, the poly(vinylidene fluoride), and the first block copolymer in the film.

22. The film of claim 1, further comprising at least one additional block copolymer having endblocks comprising poly(methyl methacrylate) and a midblock comprising poly(butyl acrylate), wherein the at least one additional block copolymer is compositionally distinct from the first block copolymer.

23. The film of claim 1, further comprising at least one ultraviolet (UV) light absorber in an amount from 0.1 wt. % to 10 wt. %, optionally further comprising at least one hindered amine light stabilizer (HALS) in an amount from 0.1 wt. % to 1 wt. %, optionally wherein the UV light absorber is present in an amount from 0.5 wt. % to 5 wt. %.

24. (canceled)

25. The film claim 1, further comprising a plurality of inorganic nanoparticulates having a median particle diameter of less than one micrometer, optionally wherein the plurality of inorganic nanoparticulates comprise metal oxides selected from the group consisting of titanium dioxide, aluminum oxide, silicon dioxide, indium oxide, tin oxide, zinc oxide, zirconium oxide, and combinations thereof.

26. (canceled)

27. The film of claim 1, wherein the film exhibits a radiation transmission of at least 90% over a radiation wavelength range from 380 nm to 3,000 nm.

28. An article comprising the film of claim 1, wherein the article is selected from the group consisting of an organic light emitting display, a lighting element, a solar reflector, a photovoltaic cell, a mirror, a window, a graphic arts display, a sign, or a combination thereof.

29. A method of making a film, comprising:
providing a molten poly(vinylidene fluoride),
providing a molten block copolymer having at least two endblock polymeric units that are each derived from a first monoethylenically unsaturated monomer comprising a methacrylate, acrylate, styrene, or combination thereof, wherein each endblock has a glass transition temperature of at least 50° C.; and at least one midblock polymeric unit that is derived from a second monoethylenically unsaturated monomer comprising a methacrylate, acrylate, vinyl ester, or combination thereof, wherein each midblock has a glass transition temperature no greater than 20° C.;
passing the molten poly(vinylidene fluoride) and the molten block copolymer through a film extrusion die; and
after exiting the film extrusion die, cooling the molten poly(vinylidene fluoride) and the molten block copolymer to a temperature of about room temperature to form the film.

30-35. (canceled)
